(19) United States
(12) Patent Application Publication
(10) Pub. No.: US 2003/0014276 A1
(43) Pub. Date: Jan. 16, 2003

(54) Storytelling by Trish

(76) Inventor: Patricia Lynn Kline, Helena, MT (US)

Correspondence Address: PATRICIA KLINE, P.O. BOX 1199, HELENA, MT, 59624, US

(21) Appl. No.: 10/173,473

(22) Filed: Jun. 17, 2002

Related U.S. Application Data
(60) Provisional application No. 60/298,777, filed on Jun. 18, 2001.

(51) Int. Cl. G06F 17/60

(52) U.S. Cl. 705/1; 434/178

(57) ABSTRACT

The interactive book-webscene business method for the creation of intellectual property combines enhances the book reading experience by integrating program applications that are Internet deliverable. These online deliverable elements are essential to the process of storytelling and are not materials simply tacked-on to supplement or compliment.

The interactive book-webscene method combines text with components of varying applications of visual and auditory entertainment delivered via the Internet. This may include, but is not limited to, graphics, animation, video and/or audio transmissions, interactive games, Internet radio, puzzles, activities and direct messaging. All components are essential to the final intellectual property. None may be excluded without compromising the property.

The interactive book-webscene method applies to any and all available text delivery formats including, but not limited to, print book, electronic (e-book) and online content delivery.

### BRIEF DESCRIPTION OF THE INVENTION

The interactive print book-internet webscene business method for the creation of intellectual property It provides an enhanced print book reading experience by integrating program applications that are internet deliverable. These online deliverable elements are essential to the process of storytelling and are not materials simply tacked-on to supplement or compliment.

The interactive print book-internet webscene is a new form of entertainment, combining the printed book with components of varying applications of visual and auditory entertainment, as well as interactive games, internet radio, puzzles, activities and direct messaging. All components are essential to the final intellectual property. None may be excluded without compromising the property.

Each webscene application is original content created as an essential component of the full execution of the book-interactive webscene story. No application has any purpose as a stand-alone unit.

But, rather, each application is as essential as each chapter in a traditional print book. The webscene can be thought of as an alternative method of presenting chapters in the book. With a webscene at the end of each print chapter, the webscene, in essence, contributes content equal to approximately half of the storyline of the book.

So essential is the webscenes to the print book, the print book to the webscenes, that neither would be a product nor fulfill a purpose in and of itself. Each component relies totally upon the existence of the other component.

### DETAILS OF THE INVENTION

These are the steps that make up the invention, in its preferred form:

1. Initial concept for storyline is developed. This requires a writer to create plot, characters and all other relevant elements of a traditional print book format.

2. The writer then creates a story flow chart for the action of the story and plot.

3. Using the flow chart, the writer determines which elements can be portrayed either visually or audibly using programming applications available for internet delivery.

4. Writer continues to scrutinize story flow chart to determine elements of the book that can provide the reader with interactivity, such as games, puzzles, activities, processes to complete away from the computer utilizing instructions provided online

5. Writer continues to scrutinize story flow chart for other programming applications that can be integrated to enhance the reader's entertainment and interactivity with the story process. A website must be designed with purpose to facilitate delivery of various programming applications as described in number four. Requires that a website be created for the purpose of delivery of webscene information to the reader of the accompanying print book.

6. Programming applications must be created to facilitate various components as described in number four.

7. Final determination of which programming applications will be used for delivery of content.

8. Assemble teams to create content which may include any or all of the following: scriptwriters, actors, musicians, video production specialists, sound production personnel, directors, FX specialists, artists, graphic artists, software game developers, software game writers, programming consultants, educational consultants, entertainment industry personnel, etc.

9. Production of online delivery components.

10. Writer writes book, developing content and storyline to integrate with the content for online delivery, including specific links to specified online content.

11. Online components loaded.

12. Print book produced.

13. Website maintained for uninterrupted delivery of online components.

The print book-interactive webscene delivery partnership is 50-50: the book provides 50% of the story; the webscenes provide the second 50%. One without the other would render the print book-interactive webscene product incomprehensible and worthless.

The novelty of this business method lies in its “process” for creation of intellectual property. The “old” ways of connecting print and technology is to write a book and supplement it with a CD-ROM or compliment it by offering websites that offer additional info on the topic (very much like facilitating research).

How the print book-interactive webscenes differ is in the entire process by which the intellectual property is created.

The parts of the interactive book-webscene business method creation of intellectual property work in this way.

You read a chapter. You go to the webscene for the next installment of information. You go back and read the next chapter. Then, you go again to the webscene, and so forth. The book “ends” on the revelation made apparent through the reader viewing the last webscene installment. If they do not view this last webscene, the reader does not know how the story ends.

Please note that webscenes may provide information by a variety of applications.

Each webscene application is original content created as an essential component of the full execution of the book-interactive webscene story. No application has any purpose as a stand-alone unit

But, rather, each webscene application is as essential as each chapter in a traditional print book. The webscene can be thought of as an alternative method of presenting chapters in the book. With a webscene at the end of each print chapter, the webscene, in essence, contributes content equal to approximately half of the storyline of the book.

Content for webscenes may be executed by utilization of any one of several programming applications. These applications may include but are not restricted to:

Static images

GIFs

Video clips

Audio clips

Internet radio broadcasts

Streaming video

Autoresponders

Interactive games

Puzzles and other activities

In addition, as technology and internet features are developed, these can also be incorporated into this business method.

For instance, five years ago, streaming video, autoresponders and internet radio did not exist. Both can be used in this business method to enhance the experience of the printed book reader.

Hence, as new applications for transfer of information and entertainment are developed for internet users, these can be examined and applied for incorporation into this interactive book-webscene business method of creation of intellectual property.

### EXAMPLE

If you went to the theatre to see a two-hour movie. You are instructed that the movie will be showing on two different screens. Only it will be divided like this:

Minutes 1-20 on Screen One

Minutes 21-40 on Screen Two

Minutes 41-60 on Screen One

Minutes 61-80 on Screen Two

Minutes 81-100 on Screen One

Minutes 101-120 on Screen Two

For whatever reason, you never go to Screen Two. You watch only the segments on Screen One. The movie ends on Screen two.

You can say you saw the movie—but how much did you comprehend? Especially if you do not even know how the movie ended?

Alternate Use:

While this business method has been designed for the creation of literary fictional intellectual property, it can be just as easily applied to any and all print products. It would require no modifications only adjustments in the creation process to align with the purpose, audience and objectives of the content to be presented. This business method can be applied across the board to non-fiction, how-to, children and adult educational, adult corporate training, English-as-Second-Language—to name but a few of the literary forms/subject/content areas concerned with creation of intellectual properties in hard copy book formats.

Amendment 3

The interactive book-webscene method may combine text with any number of components of varying applications of visual and auditory entertainment delivered via the Internet. This may include, but is not limited to, graphics, animation, video and/or audio transmissions, interactive games, Internet radio, puzzles, activities and direct messaging.

The interactive book-webscene method applies to any and all available text delivery formats including, but not limited to, print book, electronic (e-book) and online content delivery.

### STATE OF THE ART

The “function” of this invention is not presently being done.

The function of this invention is to create an online environment that is totally interactive with traditional print publications. This business method of creation of intellectual property provides for its user an essential correlation between the reading of print materials and internet interaction for the comprehension and entertainment.

Hence, as new applications for transfer of information and entertainment are developed for internet users, these can be examined and applied for incorporation into this interactive book-webscene business method of creation of intellectual property.

This business method requires that content be created using a variety of programming applications. This content has no stand-alone value. Its value is in its furtherance and completion of the editorial process begun and continued in the print book.

So essential is the webscenes to the print book, the print book to the webscenes, that neither would be a product nor fulfill a purpose in and of itself. Each component relies totally upon the existence of the other component.

There are not any combinations of existing methods that would be similar to this invention. This invention performs a function which, to be fore, has not been attempted in creating a totally interactive print-internet delivery of intellectual property.

Perhaps the closest method to this business method is the textbook-cd-rom packages of higher education. These often have print books with accompanying cd-roms, created with slides, video clips such as of lectures, etc. In most instances, this is simply “canned” information, assembled for purposes very similar to presentation in a university classroom—only, here, supplied on cd-rom. The purpose of the package is to educate and test a student, again, in much the same way as a college course.

There are also print books which, at various points in its text, list website links to go and review. These are mostly along the lines of “more information” or “more sites about this topics.”

In either case, both products are created to “stand alone” as print books. In addition, content upon their CD-ROM and/or website can “stand alone” in that it makes sense, is comprehensible, and/or has intrinsic value independent of the printed book. While they each enhance the product, the comprehension of the print product does not fail to exist simply because you do not view the CD-ROM or visit sites which might provide additional information.

Again, this business method is for print-internet interaction. There is no cd-rom involved. All content is created for internet delivery. All content from the internet site is essential for the print book. Comprehension of the print book will fail to exist without the information contained within the webscenes. The webscenes has no intrinsic value without the accompanying book. The book has no intrinsic value without the accompanying webscenes. One is useless and without value unless used in correlation with the other.

Resources:

I have been a writer for over 20 years. Of the last eight years, I have worked in children's media and education. I am familiar with print, online and software products. To date, no product on the market combines the elements of my invention in the method in which I do to create of intellectual property.

I have the catalogs of major print book and software publishers. None have a product advertised that uses the method for the creation of intellectual property. I have also searched many online e-book publishers for similar products. None could be found . . . although an e-book execution of this method would differ from the business method process for which I am making provisional application. Mine is not an “e-book” but, rather, a traditional print, hard copy publication.

Potential purchasers of my invention would include book publishers of traditional print, hard copy publications who are seeking to find a method of combining traditional print books with interactivity online, facilitated by all the media elements available through website access.

Date of Invention:

I first began work on this business method in November, 2000. At this time, I began plot development, outline and other development elements for the book. In addition, I began to do concept development of accompanying webscenes.

I first explained the concept to another approximately Jan. 7, 2001. This would be Romana Vasquez for possible business partnership.

I contracted a web design company on Mar. 22, 2001, explaining the components and web design needs and perimeters. At this time, I provided a flow chart for the website design and they began work on its development.

Reduction to Practice: The business method was first executed by being placed online Jun. 7, 2001. This included three sample chapters from the book plus webscenes. While, in the business method, the chapters will be contained in a traditional print book, samples were loaded onto the site to execute the flow of the process. The print book had not yet been printed at this date.

Publications:

The invention has never been described in printed form such as magazines. It has been mentioned in email, beginning in March, 2001, during the creation of online applications.

Prior Fillings:

No prior filings have been made.

Public Use:

A sample of the invention has been displayed by website since Jun. 7, 2001. The website address is TheGhostHunterOnline.com. sample 1.

Sale:

The invention has never been sold.

Amendment 4

The first interactive book-webscene product was released for sale on Apr. 16, 2001. This product is entitled The Ghost Hunter and the Ghost of Gettysburg (ISBN # 0-97172340-0-0). It is being sold via the Internet, direct sales and in bookstores.

Additional titles are scheduled for release and sale in 2002 and 2003. These titles and ISBN numbers are:

The Ghost Hunter and the Ghost of the Amazon Warrior (ISBN#0-9717234-1-9)

The Ghost Hunter and the Ghost of Pharaoh's Daughter (ISBN#0-9717234-2-7)

The Ghost Hunter and Tales from the Dead, Book 1 (ISBN#0-9717234-3-5)

The Ghost Hunter and the Ghost of the Warrior Prince (ISBN#0-9717234-4-3)

The Ghost Hunter and the Temple of the Dead (ISBN#0-9717234-5-1)

The Ghost Hunter and the Empire of the Dead (ISBN#0-9717234-6-x)

The Ghost Hunter and the Army of the Dead (ISBN#0-9717234-7-8)

The Ghost Hunter and Tales from the Dead, Book 2 (ISBN#0-9717234-8-6)

The Ghost Hunter's Handbook (ISBN#0-9717234-9-4)

Other Inventors:

No one else contributed to the conception or reduction to practice of the invention, except in a purely mechanical way of the contracted contributions of website designers and graphic artists.

Rights in Others:

I am under no obligation to assign any rights in the invention to any person, company or organization.

Supporting Documents:

As sketches and drawings would be of no use in establishing the validity of this business method process, I am enclosing, instead, samples chapters, including links to webscenes from The Ghost Hunter and the Ghost of Gettysburg by Trish Kline, the first book using this business method. Also included is a chapter-by-chapter outline of the book with brief mention of the webscenes. Finally, a more detailed of webscenes as provided to the graphic artists for rendering. All these materials have been submitted Jun. 13, 2001 for U.S. Copyright.

Amendment 5

Since the filing of the provisional patent on Jun. 18, 2001, the following support documentation has become available

Proof-of-Concept:

First interactive book-webscene product The Ghost Hunter and the Ghost of Gettysburg, released Apr. 16, 2002 (a copy accompanies)

Certificate of Registration from the United States Copyright Office, dated Jun. 18, 2001 (a copy accompanies)

Website www.theghosthunteronline.com launch Jun. 20, 2001 contained explanation of interactive book-webscene method; offered pre-order of product.

Press release materials submitted to book reviewers; reviews scheduled for fall 2002 magazine publications (copy accompanies)

Assistant Commissioner for Patents

Washington, D.C. 20231

Jun. 14, 2002

Dear Sir/Ms:

Enclosed is my fee to apply for a patent.

I am an individual inventor and, per your specifications, I qualify as a small entity and so claim myself as such as this time.

Thank You.

Sincerely,

Patricia Lynn Kline

3265 R Drive

P.O. Box 1199

Helena, Mont. 59624

Assistant Commissioner for Patents

Washington, D.C. 20231

Jun. 14, 2002

Dear Sir/Ms:

Please find enclosed my application for patent on my invention titled Storytelling by Trish. I previously filed a provisional patent on Jun. 18, 2001. I was unsure whether to forward only updated materials or to resubmit a revised application. I have done the later with specific documentation regarding all new materials.

These additions/revisions are designated as amendments. There are five. As these amendments pertain to materials not supplied previously (abstract and disclosure search), added statement for clarity, revision of outdated information regarding sale and support documents which have only become available since provisional filing, this does not appear to fall within your definition of amendment to claims (either addition or deletion). Therefore, I have not enclosed additional fees. If I am incorrect in this evaluation, please advise. What you have is a revised application, amendments so noted at their inclusion.

As to the search disclosure, obviously, I have conducted this myself After consulting two different attorneys and reviewing their initial analysis, it became evident that to search patents relevant to business method for creation of intellectual property was not within their scope of capabilities. Therefore, having a better understanding of the process involved with the invention, I have pursued all areas I found to be directly related to and/or associated with the interactive book-webscene method.

Regarding International search, I refer to your spec 1849 SUBJECT MATTER EXCLUDED FROM INTERNATIONAL SEARCH, section E that refers to “mere presentation of information.” As the invention is precisely that, a new method for the presentation of newly created intellectual property, it would appear to fall within the perimeters of this classification. If not, please advise.

Finally, in regards to 37 CFR 1.10 that provides for the filing of papers and fees by Express Mail with a certificate, I have filed this application by U.S. Postal Service Express Mail. The number of the Express Mail label is ______ Certificate of mailing in hereto affixed. The date on these indicates the U.S. Postal Service received them on Jun. 17, 2002. This acceptance duly meets the one-year filing date from the provisional filing documented Jun. 18, 2001.

Thank you for your consideration.

Patricia Kline

### CONTENTS

Cover Letter (Express mail Certificate of Mailing attached)

Form PTO/SB/05 (Express mail Label No. noted)

Letter Claiming Small Entity Status

Form PTO/SB/17 (2 copies with check attached)

Copy of USPTO confirmation of provisional patent filing

Form PTO/SB/01

Form PTO/SB/04

Form PTO/SB/01A

Form PTO/SB/06

PATENT APPLICATION (WITH AMENDMENTS, REVISED JUN. 17, 2002)

CLAIM

ABSTRACT

BRIEF DESCRIPTION OF INVENTION

DETAILS OF INVENTION

ALTERNATE USE

STATE OF THE ART

RESOURCES

DATE OF INVENTION

PUBLICATIONS

PRIOR FILINGS

PUBLIC USE

SALE

OTHER INVENTORS

RIGHTS IN OTHERS

SUPPORTING DOCUMENTS

Proof-of-Concept: printed book The Ghost Hunter and the Ghost of Gettysburg

United States Copyright Office certificate of registration (copy)

Outline illustrative of the interactive book-webscene method of creation of intellectual property

Sample chapters of book The Ghost Hunter and the Ghost of Gettysburg as were displayed on the website Jun. 13, 2001.

Copy of press materials sent to book reviewers

Descriptions of Amendments

Form PTO/SB/08A INFORMATION DISCLOSURE STATEMENT

ABSTRACT OF DISCLOSURE

I claim that Storytelling by Trish, the interactive book-webscene business method process for the creation of intellectual properties:

1. combines the book reading experience by integrating program applications that are Internet deliverable. These online deliverable elements are essential to the process of storytelling and are not materials simply tacked-on to supplement or compliment.

2. combines text with components of varying applications of visual and auditory entertainment delivered via the Internet. This may include, but is not limited to, graphics, animation, video and/or audio transmissions, interactive games, Internet radio, puzzles, activities and direct messaging. All components are essential to the final intellectual property. None may be excluded without compromising the property.

3. applies to any and all available text delivery formats including, but not limited to, print book, electronic (e-book) and online content delivery.
